(19) United States
(12) Patent Application Publication
(10) Pub. No.: US 2004/0260933 A1
(43) Pub. Date: Dec. 23, 2004

(54) Method of preventing tampering of program by using unique number, method of upgrading obfuscated program, and apparatus thereof

(75) Inventor: Jae-heung Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 10/836,402

(22) Filed: May 3, 2004

(30) Foreign Application Priority Data
May 20, 2003 (KR) 10-2003-0032081

(51) Int. Cl. H04L 9/00

(52) U.S. Cl. 713/193

(57) ABSTRACT

A method of preventing tampering with a program, a method of upgrading a program, and an apparatus thereof. The method of preventing tampering with a program creates a plurality of obfuscated codes by processing an original code using a plurality of obfuscation methods, generates a program unique number, determines one of the created obfuscated codes based on the unique number, and provides the selected code to a user. The method of upgrading a program creates a plurality of obfuscated codes by processing an upgrade code using a plurality of obfuscation methods, compares the created, obfuscated codes with existing obfuscated codes, and creates a plurality of patch codes based on the difference obtained through the comparison. A patch code is selected based on the unique number input by a user.

### BACKGROUND OF THE INVENTION

This application claims priority from Korean Patent Application No. 10-2003-0032081, filed on May 20, 2003 in the Korean Intellectual Property Office, the disclosure of which is incorporated herein in its entirety by reference.

1. Field of Invention

The present invention relates to a method of preventing tampering with a program and an apparatus thereof, and more particularly, to a method of preventing tampering with a program using a program-unique number, a method of upgrading a tamper-resistant program, and an apparatus thereof.

2. Description of the Related Art

With recent developments regarding the Internet, the number of service providers providing various content in an online manner has greatly increased. In the past, the term “content” has been generally used to denote the contents or tables of books or papers. Recently, however, the term “content” collectively refers to digital information provided through a variety of wired/wireless communication networks. For example, such content includes a variety of programs or information provided through the Internet or PC communications, and movies, music and game software recorded on CD-ROMs.

Although services for providing content through the Internet were free at an early stage, recently, such services charge for content use. As content is increasingly being charged for, there have been many studies conducted with respect to methods of protecting and managing digital content, which are online incorporeal assets, e.g., digital rights management (hereinafter, referred to as “DRM”).

DRM also refers to a kind of server software developed to assure safe distribution of charged content through the Web and, more importantly, to prevent unauthorized distribution thereof. DRM techniques are being developed as a measure for protecting the online privacy of commercial content, which have greatly increased in number with the broad use of file-sharing programs among users, such as Napster.

Even though online content is protected by the Copyright Act, DRM is required because it is very difficult in practice to supervise unauthorized web use and find offenders. DRM techniques are not a reckless strategy for finding online offenders after they have already committed offences but, rather, they are intended as a more reliable solution that focuses on making the peculation of web content essentially impossible. Many companies produce a variety of DRM products based on various access methods and techniques. In general, DRM products are in the form of integrated packages including all entities needed for operation, such as server software and user plug-in programs.

One conventional DRM technique is obfuscation for preventing the tampering with a program.

Obfuscation means code modification that makes reverse engineering difficult by adding troublesome operations and the like while maintaining the same function as a program code such as a source code, an object code or an execution file that has not yet been obfuscated (hereinafter, referred to as “original code”).

For example, assume that there is the following code:

i=1;

while (i<100) {

. . .

i++;

}

There is no difference in function even though the code is changed into as follows:

i=1; j=100;

while ((i<100)&&(((*j*j*(j+1)*(j+1))%4)==0)) {

. . .

i++;

j=j*i+3;

}

That is, j*j*(j+1)*(j+1) is always a multiple of 4 whether j is an odd or even number, and accordingly, ((j*j*(j+1)*(j+1))%4)==0 is always true.

Thus, there is a method of performing obfuscation by inserting a condition to a loop in such a manner. In addition to this method, there are several other obfuscation methods.

Examples of papers available online on obfuscation methods include:

http://www.cs.arizona.edu/˜collberg/Research/Publications/CollbergThomborsonLow 97c/index.html,

http://www.cs.arizona.edu/˜collberg/Research/Publications/CollbergThomborsonLow 97d/index.html, or

http://www.cs.arizona.edu/˜collberg/Research/Publications/CollbergThomborsonLow 97a/index.html.

In practice, there are one or more obfuscation methods available. Hereinafter, the description is made without mentioning specific obfuscation methods, assuming that there are various obfuscation methods that can be used.

FIG. 1A is a view illustrating the process of preventing tampering with a program in the related art.

The conventional method of preventing tampering with a program, illustrated in FIG. 1A, obfuscates an original code, which has not yet been obfuscated, such as a source code or an object code, by combining one or several known obfuscation methods, and thus creates an obfuscated code.

The obfuscated code is distributed to respective users. As methods of distributing the obfuscated code, online distribution is primarily utilized and CDs, floppy diskettes or the like are also available.

However, obfuscation is a method of resisting against reverse engineering by causing an original code to be difficult to understand. Further, the obfuscation is done without complete concealment of the original code. Thus, the original code may be discovered with sufficient time and effort. That is, if a program needs to be frequently upgraded, a malicious user who has found an original code from an obfuscated code may provide unauthorized upgrade files to all users. To address this problem, there has been developed a method capable of preventing unauthorized upgrade files from being provided to users having differently obfuscated programs by means of a plurality of obfuscation methods rather than a single obfuscation method, even though the original code has been discovered from a code obfuscated using a single obfuscation method.

FIG. 1B shows a method of preventing tampering with a program using a plurality of obfuscation methods in the related art.

That is, one original code is obfuscated using a plurality of obfuscation methods to create different codes, and the different codes created are provided to users. Even if someone discovers an obfuscation method that has been applied to a specific code and attempts to provide an unauthorized upgrade file of the code, he/she cannot provide the unauthorized upgrade file to users of programs that have been obfuscated using different obfuscation methods.

However, under the circumstances mentioned above, since a user cannot know which obfuscation method has been used for obfuscating his/her own program upon upgrading the program, it is an inconvenience for the user to acquire new upgraded code for his/her program. Moreover, the inconvenience is much greater in a case where a program is to be frequently upgraded by patch files, like online games. Further, even though a user may not have an old version of a program, he/she may acquire a new upgraded program by means of an upgrade request. To cope with this situation, it is necessary to separately verify whether a person requesting an upgrade is a legitimate user. Accordingly, such user verification also causes inconvenience.

### SUMMARY OF THE INVENTION

The present invention is conceived to solve the aforementioned problems. An object of the present invention is to provide a method capable of creating a plurality of different codes using a plurality of obfuscation methods based on an original code in order to prevent unauthorized upgrade, and a method of upgrading a program without requiring an additional authentication process upon upgrading of a plurality of obfuscated codes.

Another object of the present invention is to provide an apparatus for the disclosed methods.

According to one aspect of the present invention for achieving the objects, there is provided a method for preventing tampering with a program, comprising creating first to N-th obfuscated codes by processing an original code using N different obfuscation methods; generating a unique number; and performing a calculation on the unique number using a predetermined calculation method, and determining an obfuscated code that corresponds to a resultant value obtained through the calculation and will be provided to a user. The step of selecting one of the N obfuscated codes may be performed based on the remainder obtained by dividing the sum of some or all digits of the unique number by N.

According to another aspect of the present invention, there is provided a method for upgrading a program, wherein an obfuscated code selected based on a unique number among first to N-th obfuscated codes created by means of N different obfuscation methods is upgraded; and the method comprises the steps of creating first to N-th obfuscated upgrade codes by processing an upgrade code using the N obfuscation methods; comparing the first to N-th obfuscated upgrade codes with the first to N-th obfuscated codes and creating first to N-th patch codes from different codes obtained through the comparison; and receiving the unique number from a user, performing a calculation on the unique number using a predetermined calculation method, and determining a patch code that corresponds to a resultant value obtained through the calculation and will be provided to the user. The step of selecting one of the N patch codes may be performed based on the remainder obtained by dividing the sum of some or all digits of the unique number by N. In the meantime, to prevent a plurality of programs from being upgraded with an illegally copied specific unique number, if the number of times the unique number is received from a user exceeds a predetermined number, the patch code corresponding to the unique number to be provided to the user may not be provided.

According to a further aspect of the present invention, there is provided an apparatus for preventing tampering with a program, comprising an obfuscation unit for creating N different obfuscated codes by processing an original code using N different obfuscation methods; a code table for storing the obfuscated codes; a unique number generator for generating a unique number for identifying a distributed, individual program; and a mapping unit for receiving the unique number generated in the unique number generator, performing calculation on the unique number using a predetermined method, and determining an obfuscated code that has been stored in the code table, corresponds to a relevant value obtained through the calculation and will be provided to a user. The mapping unit may select one of the N obfuscated codes stored in the code table, based on the remainder obtained by dividing the sum of some or all digits of the unique number generated in the unique number generator by N.

According to a still further aspect of the present invention, there is provided an apparatus for upgrading a program, wherein an obfuscated code, selected based on a unique number among first to N-th obfuscated codes created by means of N different obfuscation methods, is upgraded; and the apparatus comprises an obfuscation unit for creating first to N-th obfuscated upgrade codes by processing an upgrade code using the N obfuscation methods; a comparison unit for comparing the first to N-th obfuscated upgrade codes with the first to N-th obfuscated codes and creating first to N-th patch codes from different codes obtained through the comparison; a code table for storing the first to N-th patch codes; and a mapping unit for receiving the input unique number, performing calculation on the unique number using a predetermined calculation method, and determining a patch code that has been stored in the code table corresponding to a resultant value obtained through the calculation that will be provided to the user. The mapping unit may select one of the N obfuscated codes stored in the code table, based on the remainder obtained by dividing the sum of some or all digits of the input unique number by N. Meanwhile, the apparatus may further comprise a counter for counting the number of times the same unique number is input so that if the number of times the unique number is input exceeds a predetermined number, the patch code is not provided to the user corresponding to the unique number.

### BRIEF DESCRIPTION OF THE DRAWINGS

The above and other objects and features of the present invention will become apparent from the following description of preferred embodiments given in conjunction with the accompanying drawings, in which:

FIG. 1A is a view illustrating a conventional process of preventing tampering with a program;

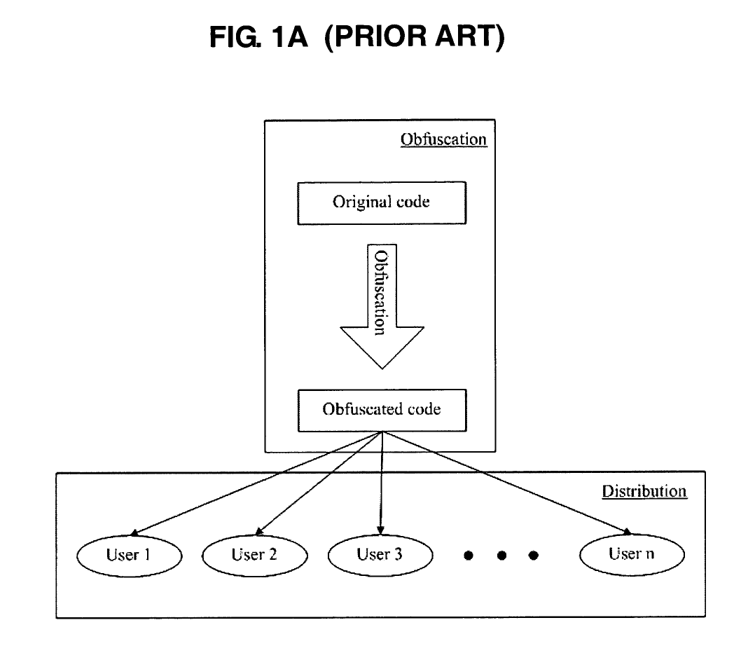

FIG. 1B is a view illustrating a conventional method of preventing tampering with a program using a plurality of obfuscation methods;

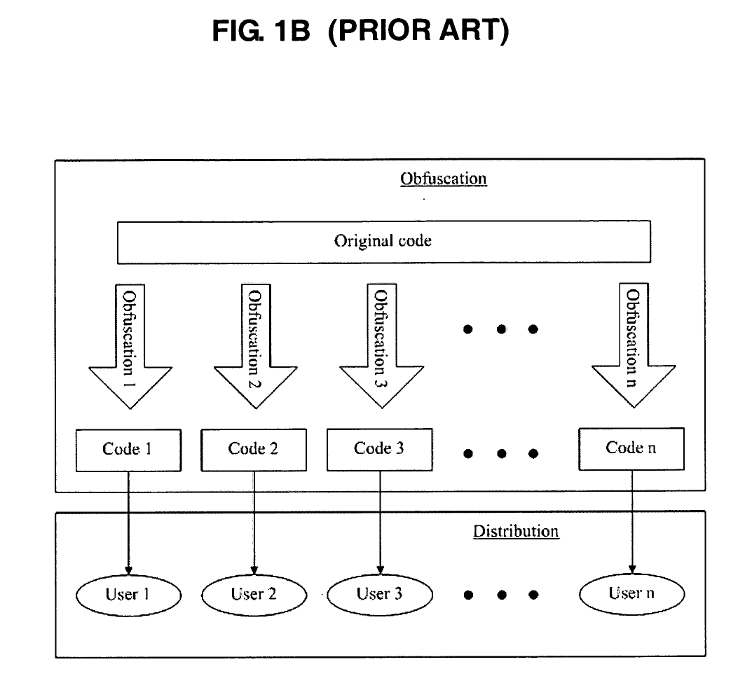

FIG. 2 is a view showing a system environment according to one embodiment of the present invention;

FIG. 3 is a view illustrating the process of creating a code table for obfuscation to prevent tampering with a program according to another embodiment of the present invention;

FIG. 4 is a view illustrating the process of preventing tampering with a program according to another embodiment of the present invention;

FIG. 5 is a view illustrating the process of creating a code table for upgrading a program according to a further embodiment of the present invention; and

FIG. 6 is a view illustrating the process of upgrading a program according to the further embodiment of the present invention.

### DETAILED DESCRIPTION OF THE INVENTION

Hereinafter, preferred embodiments of the present invention will be described in detail with reference to the accompanying drawings.

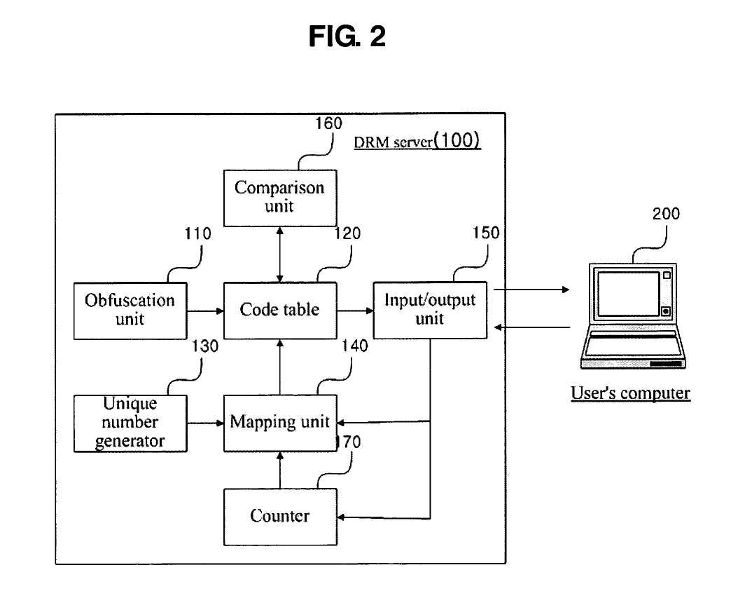

FIG. 2 is a view showing a system environment according to an embodiment of the present invention.

A DRM server 100 for performing tamper prevention and upgrade provision of a program comprises an obfuscation unit 110 for obfuscating an original code or upgrade code, a code table 120 for storing the obfuscated code, a unique number generator 130 for generating a unique number, a mapping unit 140 for receiving the unique number and allowing one of several obfuscated codes stored in the code table to be determined, a comparison unit 160 for generating a patch code by comparing a new upgrade code with an existing obfuscated code when the new upgrade code has been obfuscated and sending the generated patch code to the code table, an input/output unit 150 for enabling the transmission and reception of data to and from a user's computer 200 through the Internet or other media, and a counter 170 for counting the number of times the transmission of the unique number from the user's computer 200 to the input/output unit 150 for the purpose of requesting an upgrade is performed.

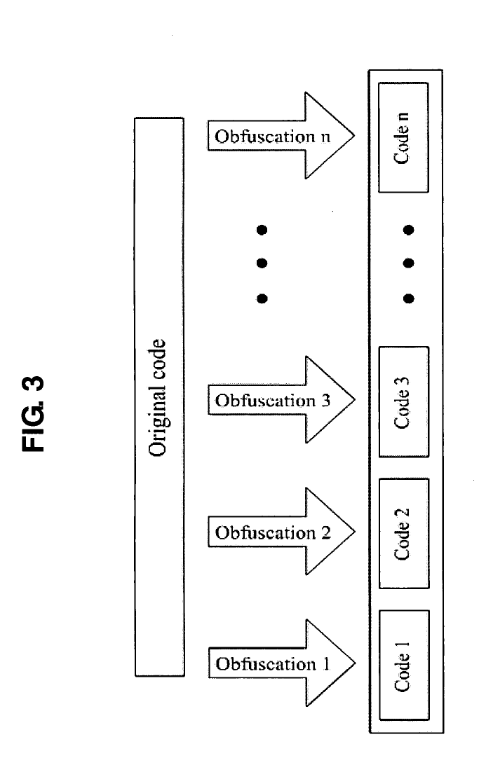

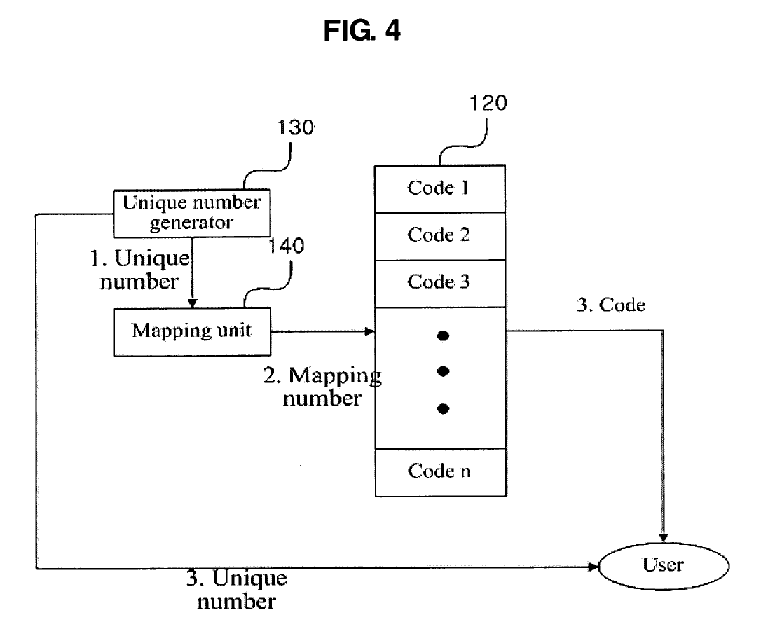

A method of preventing the tampering with a program will be first described with reference to FIGS. 3 and 4.

FIG. 3 illustrates the process of creating a code table for obfuscation to prevent tampering with a program according to another embodiment of the present invention, and FIG. 4 illustrates a method of preventing tampering with a program by using the code table generated by the process of FIG. 3.

First, the obfuscation unit creates N obfuscated codes (codes 1-n, FIG. 3) by processing an original code by means of N obfuscation methods. Herein, “original code” refers to source code or object code of a program, or an execution file thereof that has not been obfuscated. The first to n-th obfuscated codes are stored in the code table 120 (FIG. 4). In the present invention, the code table refers to a space for storing obfuscated codes, or a collection of obfuscated codes.

Referring first to FIG. 4, the unique number generator 130 generates a unique number, e.g., a serial number, for each program to be distributed to a user. The mapping unit 140 receives the unique number and generates a relevant mapping number for determining an obfuscated code processed using a predetermined calculation method. For example, assuming that the unique number is “123456789012” (i.e., 12 digits) and the number corresponding to an obfuscated code is 16, an operation of “123456789012 mod 16” yields “1” and accordingly a first obfuscated code corresponding to “1” becomes a code to be distributed for the unique number “123456789012.” Since the first code has been determined as the code to be distributed, the unique number “123456789012” and the first obfuscated code are distributed to the user.

Meanwhile, the predetermined calculation method is not limited to the above-mentioned example and may include a method using a hash function. As for the method of distributing the unique number and the code to the user, the unique number and the code can be sent via the input/output unit 150 to the user's computer 200, through the Internet. Alternatively, a CD or another storage medium in which the first code and the unique number “123456789012” are stored may be provided to the user.

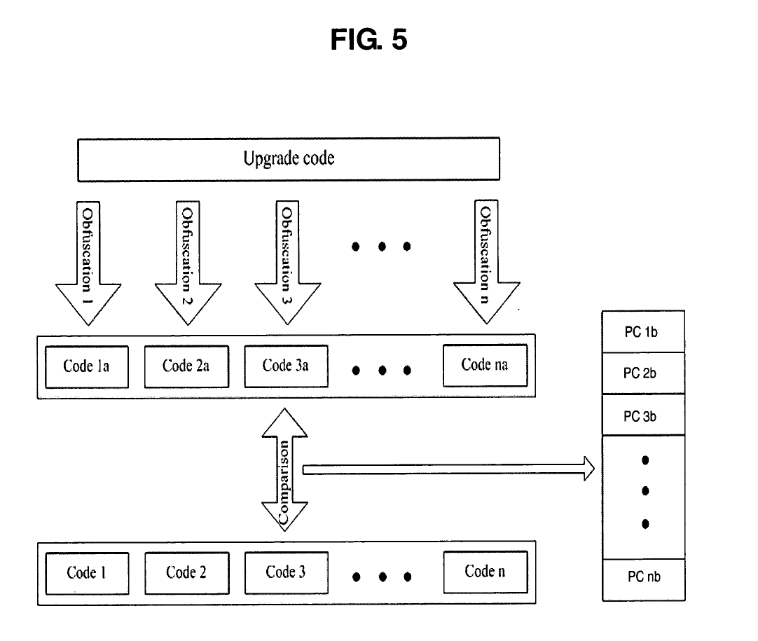

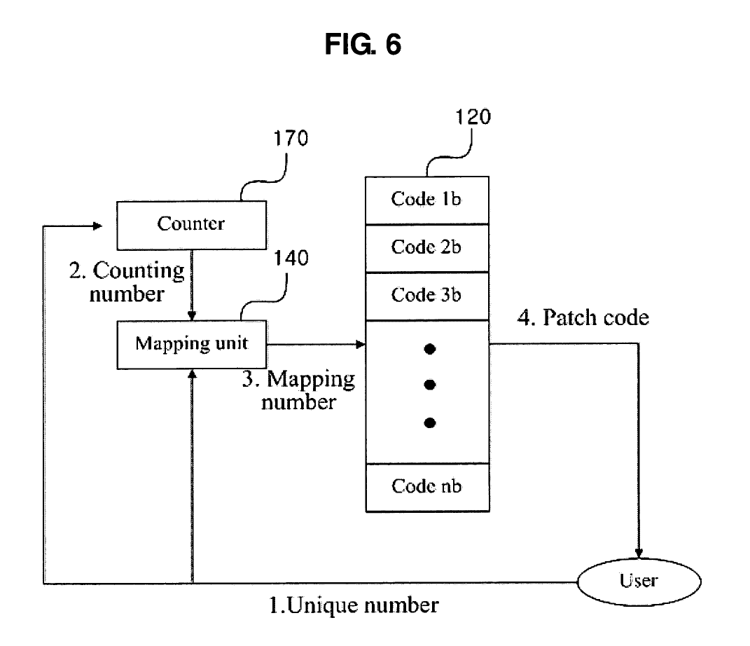

Next, a method of upgrading a program will be described with reference to FIGS. 5 and 6.

FIG. 5 illustrates a process of creating a code table for upgrading a program according to a further embodiment of the present invention, and FIG. 6 shows a process of upgrading a program by using the code table created through the process of FIG. 5.

The obfuscation unit creates N obfuscated upgrade codes (codes 1a-na in FIG. 5) by processing an upgrade code by means of n obfuscation methods. The comparison unit compares the obfuscated upgrade codes with the existing obfuscated codes (codes 1-n) stored in the existing code table 120. A comparison unit creates N patch codes (codes PC1b-PCnb) by comparing the obfuscated upgrade codes with the existing obfuscated codes. The created first to n-th patch codes are stored in the code table 120.

To upgrade a program installed in the user's computer in an online manner, a unique number from the user's computer should be first sent to the DRM server. The counter 170 (FIG. 6) counts the number of times an upgrade request with the received unique number is sent a precludes upgrading an illegally copied program. The mapping unit 140 determines a patch code corresponding to the received unique number, and the determined patch code is sent to the user's computer. Meanwhile, if the count exceeds the predetermined number of times e.g., 5 or more times, the relevant unique number may be regarded as a unique number of an illegally copied program. Thus, a message such as “Please contact the administrator of the DRM server” can be sent instead of the patch code corresponding to the unique number.

It will be understood by those skilled in the art that the present invention can be implemented in other specific forms without changing the technical spirit or essential features of the present invention. For example, although the N different obfuscation methods have been primarily described above, the present invention is not limited thereto. Alternatively, N obfuscation methods may be made by combining less than N obfuscation methods. In other words, if N is 10 and there are five obfuscation methods, ten obfuscation methods can be produced by combining two of the five obfuscation methods.

Meanwhile, although the respective components of the present invention described above may be implemented with hardware, the present invention is not limited thereto. Implementation thereof with software modules or a combination of hardware and software modules also falls within the technical spirit of the present invention.

According to the present invention described above, since a plurality of obfuscated codes created by applying a plurality of obfuscation methods to one original code are distributed to users, even though a competitor or malicious user may be aware of a method of cracking the obfuscation applied to any one of the obfuscated codes distributed to a user, such a cracking method cannot be applied to other obfuscated codes distributed to other users.

Further, in case of a program requiring frequent upgrading, if codes obfuscated using a plurality of obfuscation methods are distributed in the related art, it is difficult to know which obfuscated method has been applied to a code of a program that a user currently utilizes. Thus, there arises a difficulty in upgrading the program. According to the present invention, once a unique number of a program that a user currently utilizes is determined, it is possible to determine which obfuscation method has been used for the program, thereby facilitating upgrade of the program.

Meanwhile, according to the present invention, even in a case where a few unauthorized copies have already been made, there is an advantage in that further unauthorized copies can be prevented by limiting the number of times patches for a program having a specific unique number are sent.

It should be understood, therefore, that the aforementioned embodiments are only illustrative in all respects and the present invention is not limited thereto. The scope of the present invention is defined by the appended claims rather than the detailed description of the invention. All changes or modifications made from the spirit and scope of the invention and equivalents thereof should be construed as falling within the scope of the invention.

What is claimed is:

1. A method of preventing tampering with a program, the method comprising:
(a) creating first to N-th obfuscated codes by processing an original code using N different respective obfuscation methods;
(b) generating a unique number;
(c) performing a calculation on the unique number using a predetermined calculation method; and
determining an obfuscated code that corresponds to a resultant value obtained by the calculation.

2. The method as claimed in claim 1, wherein step (c) comprises selecting one of the N obfuscated codes based on a remainder obtained by dividing by N the sum of some or all of the digits of the unique number.

3. A method of upgrading a program, wherein:
an obfuscated code selected based on a unique number having one or more digits among first to N-th obfuscated codes created by N different obfuscation methods is upgraded; and
the method comprises;
(a) creating first to N-th obfuscated upgrade codes by processing an upgrade code using the N obfuscation methods;
(b) comparing the first to N-th obfuscated upgrade codes created in step (a) with the first to N-th obfuscated codes and creating first to N-th patch codes from different codes obtained through the comparison; and
(c) receiving the unique number from a user, performing a calculation on the unique number using a predetermined calculation method, and determining a patch code that corresponds to a resultant value obtained by the calculation.

4. The method as claimed in claim 3, wherein step (c) comprises selecting one of the N patch codes based on a remainder obtained by dividing by N the sum of some or all of the digits of the unique number.

5. The method as claimed in claim 3, wherein if the number of times the unique number is received from a user exceeds a predetermined value, the patch code corresponding to the unique number is not provided to the user.

6. An apparatus for preventing tampering with a program, comprising:
an obfuscation unit operable to create N different obfuscated codes by processing an original code using N different obfuscation methods;
a code table operable to store the obfuscated codes;
a unique number generator operable to generate a unique number having one or more digits used to identify a distributed, individual program; and
a mapping unit operable to receive the unique number generated in the unique number generator, performing a calculation on the unique number using a predetermined method, and determining an obfuscated code that has been stored in the code table and that corresponds to a relevant value obtained by the calculation.

7. The apparatus as claimed in claim 6, wherein the mapping unit selects one of the N obfuscated codes stored in the code table, based on a remainder obtained by dividing by N the sum of some or all of the digits of the unique number generated in the unique number generator.

8. An apparatus of upgrading a program, wherein an obfuscated code selected based on a unique number, having one ore more digits, among first to N-th obfuscated codes created by N different obfuscation methods is upgraded,
the apparatus comprising:
an obfuscation unit operable to create first to N-th obfuscated upgrade codes by processing an upgrade code using the N obfuscation methods;
a comparison unit operable to compare the first to N-th obfuscated upgrade codes with the first to N-th obfuscated codes, and create first to N-th patch codes from different codes obtained by the comparison;
a code table operable to store the first to N-th patch codes; and
a mapping unit operable to receive the unique number, perform a calculation on the unique number using a predetermined calculation method, and determine a patch code that has been stored in the code table corresponding to a resultant value obtained by the calculation.

9. The apparatus as claimed in claim 8, wherein the mapping unit is further operable to select one of the N obfuscated codes stored in the code table, based on the remainder obtained by dividing by N the sum of some or all of the digits of the unique number.

10. The apparatus as claimed in claim 8, further comprising:
a counter operable to count a number of times the same unique number is used so that if the number of times the unique number is used exceeds a predetermined number, the patch code is not provided.
